(19) United States
(12) Patent Application Publication
(10) Pub. No.: US 2005/0242949 A1
(43) Pub. Date: Nov. 3, 2005

(54) Agricultural data collection system

(76) Inventor: Charles C. Morehouse, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/835,177

(22) Filed: Apr. 30, 2004

(51) Int. Cl. G08B 1/08

(52) U.S. Cl. 340/539.26; 340/870.01; 340/572.1

(57) ABSTRACT

A system for data collection regarding agricultural elements includes a reader device having an interface for generating RF waves. The system also includes a plurality of electronic devices associated with agricultural elements. The electronic devices are located in a relatively fixed positioned with respect to the associated agricultural elements and have radio frequency identification devices (RFIDs) configured to activate one or more sensors for collecting at least one condition in response to receipt of the RF waves from the reader device. In addition, the electronic devices are configured to transmit data collected by the one or more sensors to the reader device.

### BACKGROUND OF THE INVENTION

Radio frequency identification devices (RFIDs) are devices that receive power and communicate via radio frequency waves transmitted from a reader device equipped to transmit the radio frequency waves and support communications protocols. RFID technology is used in a number of applications ranging from identification of products, people and animals to tracking inventory of perishable and non-perishable goods. Another application is the tracking of automobiles equipped with RFIDs as they pass through tollbooths, and the tracking of products and inventory during movement through a delivery of storage process or function.

Some types of RFIDs are configured to transmit unique identification signals such that the items to which they are associated may be easily identified. For example, these types of RFIDs are used to control access to certain people based upon their identifications. Other types of RFIDs have been known to incorporate other devices (such as sensors) to detect temperature, weight, and expiration dates, which are generally used in the food industry, or to track the environment encountered by the tagged item during its life.

The reader devices employed in the applications described above are either positioned in a stationary location and the RFIDs associated with the items or animals are interrogated as the items or animals pass through or near the reader devices, or are carried near to the items where they can interrogate the status of the item in a non-contact manner. As described above, RFIDs are typically either used with items that are movable, for instance, automobiles, people, perishable goods, and animals, or stationary items such as components of structures which can be interrogated by the portable readers. In these regards, maintaining the reader device in a fixed location and obtaining information from the RFIDs from the items as they pass near the reader device, or maintaining the reader in a portable mode is acceptable for interrogating items fixed in space such as structures, is generally sufficient for known RFID applications.

### SUMMARY OF THE INVENTION

A system for data collection regarding agricultural elements includes a reader device having an interface for generating RF waves. The system also includes a plurality of electronic devices associated with agricultural elements. The electronic devices are located in a relatively fixed positioned with respect to the associated agricultural elements and have radio frequency identification devices (RFIDs) configured to activate one or more sensors for collecting at least one condition in response to receipt of the RF waves from the reader device. In addition, the electronic devices are configured to transmit data collected by the one or more sensors to the reader device.

### BRIEF DESCRIPTION OF THE DRAWINGS

Features of the present invention will become apparent to those skilled in the art from the following description with reference to the figures, in which:

FIG. 1 shows a simplified plan view of an area containing a plurality of agricultural elements, according to an embodiment of the invention;

FIG. 2 illustrates an enlarged side elevational view of an agricultural element, in this case a tree, taken along lines II-II of FIG. 1, according to an embodiment of the invention;

FIG. 3 is a block diagram of a data collection system composed of a reader device and an electronic device, according to an embodiment of the invention;

FIG. 4 illustrates a flow diagram of an operational mode of a method for data collection, which employs a reader device and an electronic device, according to an embodiment of the invention;

FIG. 5 illustrates a flow diagram of an operational mode of a method for implementing resource allocation based upon data collected by a reader device from an electronic device, according to an embodiment of the invention; and

FIG. 6 is a block diagram illustrating a computer system, which may be used as a platform for executing one or more of the functions of the reader device and computing device disclosed herein, according to an embodiment of the invention.

### DETAILED DESCRIPTION OF THE INVENTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

According to an embodiment of the invention, radio frequency identification device (RFID) technology is employed to detect and collect information pertaining to one or more conditions at various relatively fixed locations of a predetermined area. More particularly, electronic devices equipped with RFID technology are installed or otherwise positioned at various desired relatively fixed locations in the predetermined area. Although the electronic devices may be installed for placement at fixed locations, the electronic devices may move due to, for instance, wind effects, relocation, changes to the predetermined area, and various environmental effects.

The electronic devices may also be equipped with at least one sensor configured to detect the one or more conditions. The types of sensors supplied on the electronic devices may be selected upon the desired one or more conditions to be detected. In addition, the electronic devices are generally passive devices, that is, they do not actively transmit detected data obtained by the at least one sensor. Instead, the electronic devices are generally powered through receipt of radio frequency waves transmitted by a reader device. In this regard, the electronic devices are configured to transmit detected information when interrogated by the reader device. In another example, the electronic devices may store energy from the reader device in an on-board energy storage component to allow for an extended measurement protocol or series of measurement protocols. In addition, the results of the measurements may be stored in a memory, and the results may be transmitted at a later time to the reader device.

In one application, the electronic devices may be positioned at various locations in an area intended for agricultural use. As an example, the area may comprise an orchard and the electronic devices may be positioned in or adjacent to the trees of the orchard. As another example, the area may comprise a vineyard and the electronic devices may be positioned in or adjacent various vines.

The reader device may comprise a portable apparatus, such as, for instance, a portable digital assistant (PDA), a laptop computer, etc., to accompany the essential radio-frequency communication components. In addition, the reader device may comprise a device capable of communicating with another computing device, for instance, a desktop computer, a laptop computer, a PDA, etc. In any regard, the reader device may be capable of transmitting sufficient energy to the electronic device to enable sufficient power for operation of the sensors as well as for transmission of the information detected by the sensors. The energy transmission capacity of the reader device may be configured to be sufficient for the electronic device, such that, sufficient energy transmission occurs when the reader device is within, for instance, 2-20 or more feet from the electronic device.

In an example, the reader device may also be mounted or otherwise carried on a motorized vehicle. In this example, the reader device may comprise a device that is relatively larger than a handheld device and may include or draw power from a larger power supply. In addition, the reader device may comprise a computing device, which may be used to store, for instance, information obtained from the electronic devices. Moreover, the reader device may be configured to communicate with a separate computing device, which may also be carried on the motorized vehicle and may be configured to receive information directly from the reader device. As an alternative, the reader device and/or the computing device may be equipped with a transmitting device capable of transmitting the information to a remotely located computing device.

Through implementation of the electronic devices and the reader devices disclosed herein, various conditions in predetermined areas may be collected in relatively simple and inexpensive manners. The collected information may be employed to generally enable further cost saving measures, such as, for instance, optimized utilization of resources. In addition, the collected information may be employed to maintain conditions around various elements within predetermined limits. For instance, the application of fertilizer, pesticide, minerals, and the like, may be directed based upon the collected information.

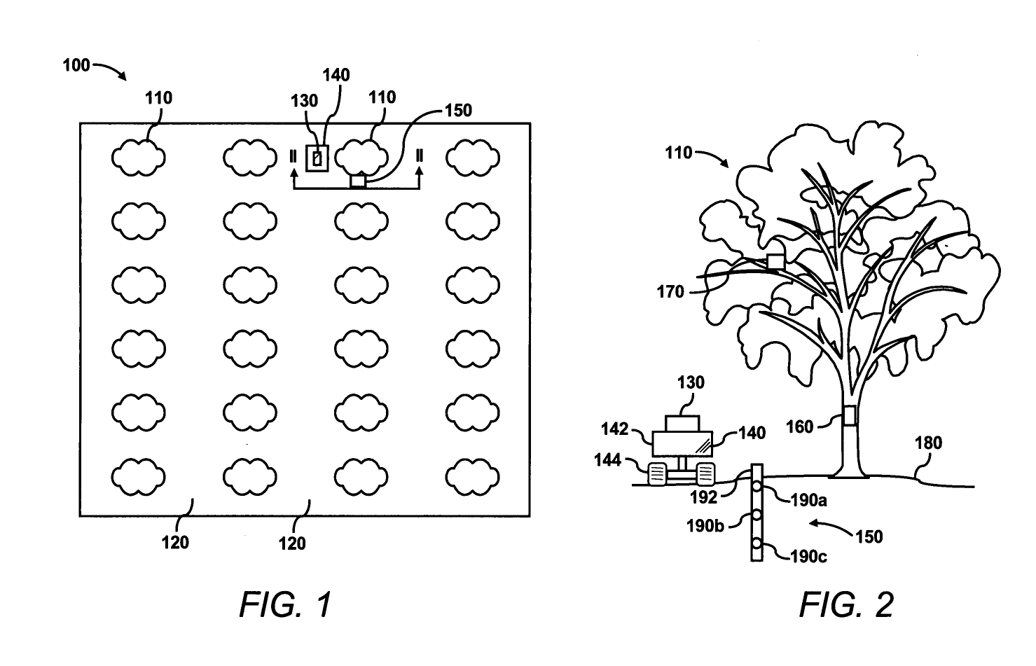

With reference first to FIG. 1, there is shown a plan view of an area 100 containing a plurality of agricultural elements 110. The area 100 depicted in FIG. 1A is a simplified illustration and may thus contain additional components and some of the components depicted therein may be removed and/or modified. For instance, the area 100 may include any number of agricultural elements 110 arranged in any reasonably suitable configuration.

The area 100 is illustrated as an orchard and the agricultural elements 110 are depicted as trees, for instance, configured to grow apples, oranges, grapefruit, almonds, walnuts, vines, etc. In addition, the agricultural elements 110 are depicted as being arranged in a plurality of relatively evenly spaced columns and rows such that a number of aisles 120 are formed between the agricultural elements 110. The aisles 120 may enable relatively easy traversal between the agricultural elements 110. Although specific reference is made to an orchard containing a number of trees, the area 100 may include other types of areas where it may be beneficial to collect one or more conditions at various relatively fixed locations. For instance, the area 100 may include a vineyard and the agricultural elements 110 may comprise vines configured to grow grapes or other fruits and vegetables.

Also shown in FIG. 1 is a reader device 130 positioned on a motorized vehicle 140. The motorized vehicle 140 may comprise a human driven platform, such as, a tractor, an automobile, etc., or the motorized vehicle 140 may comprise an automated device, for instance, a robotic device capable of being programmed to perform various functions in the orchard 100. The motorized vehicle 140 may be used to support the reader device 130, for instance, in situations where the area 100 is relatively large. The vehicle 140 may thus be configured to traverse the aisles 120 to transmit radio frequency (RF) waves to electronic devices 150 (only one is shown in FIG. 1) having RFIDs as well as to collect information from sensors of the electronic devices 150.

The electronic devices 150 may be positioned with respect to one or more of the agricultural elements 110. In this regard, electronic devices 150 may be positioned with respect to each of the agricultural elements 110, or the electronic devices 150 may be positioned with respect to various ones of the agricultural elements 110. The manners in which the reader device 130 and the electronic devices 150 may be operated are described in greater detail hereinbelow.

Although a single reader device 130 positioned on a single motorized vehicle 140 is illustrated in FIG. 1, any reasonably suitable number of reader devices 130 and motorized vehicles 140 may be employed for data collection. Thus, for instance, a plurality of reader devices 130 and motorized vehicles 140 may be used in relatively large areas 100 or to collect the data in a relatively shorter amount of time since a number of reader devices 140 may be employed to collect the data substantially concurrently. Alternatively, the reader device 130 may comprise a handheld or other type of device, which a user may carry or otherwise implement to collect the data. In addition, a subset of the sensor devices may be connected through wires to an RFID communications station (not shown), which is interrogated by the reader device 140.

Referring now to FIG. 2, there is shown an enlarged side elevational view of an element 110, in this case a tree, taken along lines II-II of FIG. 1. FIG. 2 shows in greater detail various locations on and around the element 110 where various electronic devices 150-170 may be positioned. In a first example, a first electronic device 150 is illustrated as being buried in the ground 180 in a location near the element 110. The first electronic device 150 includes at least one sensor 190a configured to detect a condition in the ground 180 near the element 110. For instance, the at least one sensor 190a may be designed to detect at least one of a moisture and a mineral (for instance, nitrogen, phosphorous, zinc, boron, etc.) content at a certain level below the ground 180 level. By way of example, the at least one sensor 190a may be positioned to detect the moisture content in the ground 180 below a frost level. In addition, the first electronic device 150 may include additional sensors 190b-190c, which may be similar to the sensor 190a. In this regard, as shown in FIG. 2, the sensors 190a-190c may be positioned at various depths in the ground 180 to thus collect information at the various depths.

The first electronic device 150 is shown as including a portion 192 which extends above the ground 180. However, the portion 192 may be in proximity to the surface of the ground 180. In any respect, the portion 192 may comprise a receiving element and a transmitting element configured to enable receipt of RF waves from the reader device 130 and to enable transmission of collected data to the reader device 130. The portion 192 may be networked with each of the sensors 190a-190c to thus enable the sensors 190a-190c to receive energy from the reader device 130 and to transmit information to the reader device 130. In this regard, the portion 192 generally provides a communication path with the reader device 130 that may not encounter substantial interference from the ground 180. In addition, the portion 192 may operate as an RFID communications station configured to communicate with the reader device 130.

The information obtained from the first electronic device 150 may be employed in determining, for instance, the amount of water to be supplied to the tree 110. In addition, this information may be used to determine whether additional fertilizer should be added to the soil around the tree 110. In this regard, a user may substantially optimize water and/or fertilizer usage by supplying either of these resources as they are needed.

Also shown in FIG. 2 is a second electronic device 160 positioned in a somewhat middle portion of the tree 110. It should, however, be understood that the second electronic device 160 may be positioned at any reasonably suitable location on the element 110 without deviating from a scope of the second electronic device 160 described herein. The second electronic device 160 may also be configured with an RFID and at least one sensor configured to detect one or more conditions. In the example where the element 110 is a tree, the at least one sensor may be configured to detect growth of the tree 110, sap flow through the tree, mineral and other material content in the tree, etc. In the case of growth detection, the sensor may comprise an apparatus configured to, for instance, detect changes in the circumference of the tree 110.

As with the first electronic device 150, the second electronic device 160 may be configured to communicate the information collected by the at least one sensor to the reader device 130. The collected data may also be used to substantially minimize resource usage. Thus, for instance, the growth and/or sap production of the tree 110 may be used to determine when fertilizer should be supplied to the tree 110. Fertilizer supply may also be determined based upon the detected mineral or other material content in the tree 110. In addition, the collected data may be used to determine the health of the tree 110 and corrective measures may be employed to generally ensure that tree 110 remains healthy.

A third electronic device 170 is also shown in FIG. 2. The third electronic device 170 is depicted as being located among, for instance, various leaves of the tree 110. In this regard, the third electronic device 170 may be implanted or otherwise attached to a branch of the tree 110. Again, the third electronic device 170 may include an RFID and at least one sensor for detecting one or more conditions. The at least one sensor may be configured to detect, for instance, the general health of the tree 100, as described hereinabove. In addition, the at least one sensor may be configured to detect insects in the tree 110. In this case, the at least one sensor may comprise any reasonably suitable commercially available sensor capable of detecting insects.

The data collected from the third electronic device 170 may be employed to control, again, the fertilizer application on the tree 110. In addition, the collected data may be employed to control pesticide application onto the tree 110. Thus, for instance, pesticide may be applied to the tree 110 when the at least one sensor detects a sufficiently large number of insects, which may warrant the application of the pesticide. In this regard, the use of pesticides may be substantially limited to those trees 110 that require the pesticides, which may be beneficial to the environment and may reduce costs associated with use of the pesticides.

The motorized vehicle 140 is also shown in greater detail in FIG. 2. As shown, the motorized vehicle 140 generally includes a platform 142 and wheels 144. The platform 142 may include a seat, steering device, etc., to enable the motorized vehicle 140 to traverse to various locations in the area 100. Alternatively, the motorized vehicle 140 may comprise a robotic device or a remotely controlled device capable of being maneuvered to various locations in the area 100 to thereby collect data from the electronic devices 150-170.

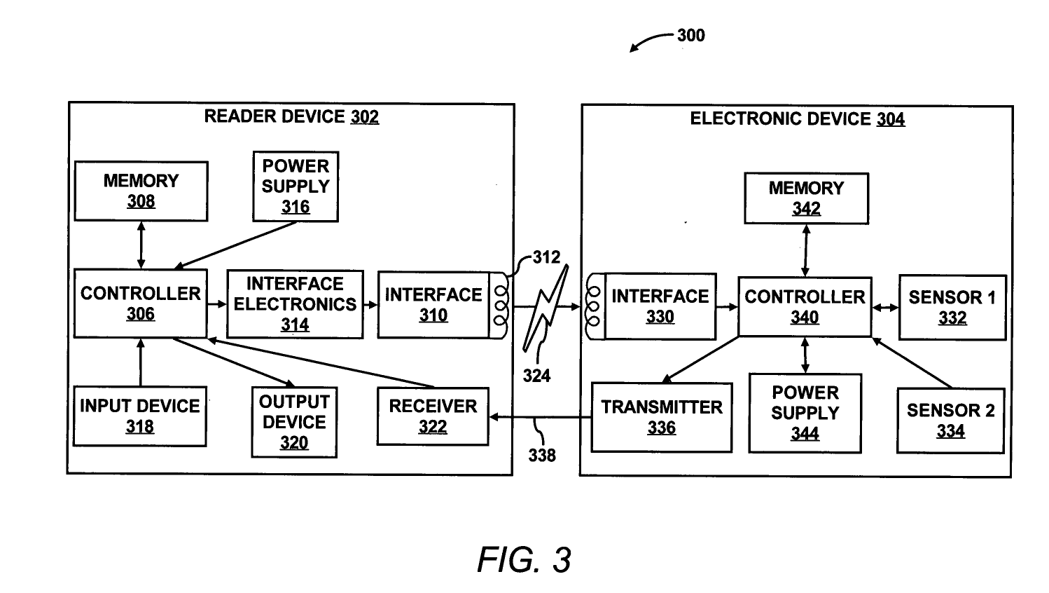

With reference now to FIG. 3, there is shown a block diagram 300 of a data collection system composed of a reader device 302 and an electronic device 304. It should be understood that the following description of the block diagram 300 is but one manner of a variety of different manners in which such a data collection system may be configured. In addition, it should be understood that the block diagram 300 may include additional components and that some of the components described herein may be removed and/or modified without departing from the scope of the invention. For instance, the block diagram 300 may include any number of reader devices and electronic devices 304, as well other components that may be implemented in the operations of the data collection system depicted in FIG. 3.

The reader device 302 may comprise the reader device 130 disclosed hereinabove and illustrated in FIGS. 1 and 2. In addition, the electronic device 304 may comprise any of the electronic devices 150-170 disclosed hereinabove and illustrated in FIGS. 1 and 2. In this regard, the reader device 130 and one or more of the electronic devices 150-170 may comprise the elements described hereinbelow and illustrated in the block diagram 300.

The reader device 302 is illustrated as including a controller 306. The controller 306 may be configured to control operations of the reader device 302. Thus, for instance, the controller 306 may comprise a microprocessor, a micro-controller, an application specific integrated circuit (ASIC), and the like. In performing various applications of the reader device 302, the controller 304 may access software or other algorithms stored in a memory 308. The memory 308 may be implemented, for instance, as a combination of volatile and non-volatile memory, such as DRAM, EEPROM, flash memory, and the like.

The controller 306 is configured to operate an interface 310. The interface 310 is configured to supply radio frequency (RF) signals or waves to the electronic device 304 through a coil 312. The manners employed by the controller 306 in operating the interface 310 may be consistent with manners currently employed in RFID technology. Thus, a detailed description of the manners in which the RF signals are created and transmitted to the electronic device 304 is omitted. The controller 306 may be configured to transmit control signals through interface electronics 314. The interface electronics 314 may act as an interface between the controller 306 and the interface 310. By way of example, the interface electronics 314 may control power delivery to the interface 310 from a power supply 316.

The power supply 316 may comprise any reasonably suitable commercially available power source capable of providing sufficient power to the reader device 302 to perform the various functions described herein. Thus, for instance, the power supply 316 may comprise a direct current (DC) power source, an alternating current (AC) power source, a solar collector, a power generator, a fuel cell, and the like.

Instructions for the controller 306 may be received through an input device 318. The input device 318 may include, for instance, a keyboard, a mouse, a computer system having its own input device, etc. The instructions may also be stored in the memory 308 for reference by the controller 306. Examples of suitable instructions may include, for instance, the frequencies at which the RFIDs of the electronic devices are configured to receive the RF signals as well as the frequencies at which the reader device 302 is configured to receive information from the electronic device 304.

The reader device 302 may also include an output device 320. The output device 320 may be configured as a display or other type of device which may communicate to a user various information. Although not shown, an adaptor or driver may be interfaced between the controller 306 and the output device 320 to thus enable the controller 306 to control the output device 320. Information outputted by the controller 306 may include, for instance, data collected from the electronic device 304.

The reader device 302 is also depicted as including a receiver 322. The receiver 322 may comprise any reasonably suitable commercially available apparatus capable of receiving information from the electronic device 304. Data received from the receiver 322 may be directed to the controller 306, which may store the collected data in the memory 308.

As an alternative to the reader device 302 illustrated in FIG. 3, the reader device 302 may comprise a relatively simpler construction. For instance, the reader device 302 may comprise the controller 306, the interface 310 and the receiver 322. In this example, the reader device 302 may be configured to communicate collected data to a separate computing device, such as, a computer system, a laptop computer, a PDA, etc. The separate computing device may thus include a memory configured to store the collected data. In addition, the power supply 316 may form a component separate from the reader device 302 and possibly separate from the computing device.

Although not shown in FIG. 3, the reader device 302 may be positioned or otherwise supported by the motorized vehicle 140 depicted in FIGS. 1 and 2. In the event that the motorized vehicle 140 is not a user mounted vehicle, the motorized vehicle 140 may be controlled by a computing device, for instance, the controller 306 or a separate controller (not shown). In this case, the motorized vehicle 140 may comprise a remotely controlled or automated device. In the former case, the motorized vehicle 140 may include mechanisms for enabling remote control of the motorized vehicle 140 by a user. In the latter case, the motorized vehicle 140 may include a controller configured to receive programming for instructing the motorized vehicle 140 on how to traverse the area 100 to collect data from variously situated electronic devices 304.

The electronic device 304 includes RFID technology to enable the electronic device 304 to receive power through RF waves 324 emitted by, for instance, the interface 310 of the reader device 302. In this regard, the electronic device 304 also includes an interface 330 configured to receive the RF waves 324 and to convert the RF waves 324 into electrical energy for the electronic device 304. The interface 330 of the electronic device 304 may function in manners generally known to those of ordinary skill in the art. In addition, the interface 330 may comprise any reasonably suitable commercially available RFID interface device.

By way of example, the electrical energy from the interface 330 may be used to power one or more sensors. In the data collection system of FIG. 3, a first sensor 332 and a second sensor 334 are illustrated. The first sensor 332 and the second sensor 334 may be configured as any of the sensors described hereinabove with respect to the electronic devices 150-170. In addition, although two sensors 332 and 334 are illustrated in FIG. 3, the electronic device 304 may include any reasonably suitable number of sensors, for instance, one or more sensors.

In its most basic form, the electronic device 304 may be configured such that the sensors 332 and 334 are activated when the interface 330 supplies the sensors 332 and 334 with electrical energy. The sensors 332 and 334 may detect one or more conditions and a transmitter 336 may receive electrical energy from the interface 330 to transmit the detected condition information to the reader device 302. The transmission of information from the electronic device 304 to the reader device 302 is illustrated as the arrow 338. In this regard, the electronic device 304 may be configured to detect the one or more conditions and to transmit the detected condition information when the electronic device 304 receives RF signals from the reader device 302.

In the example shown in FIG. 3, the electronic device 304 includes a controller 340 configured to control operations of the electronic device 332. The controller 340 may comprise, for instance, a microprocessor, a micro-controller, an application specific integrated circuit (ASIC), and the like. In performing various applications of the electronic device 304, the controller 340 may access software or other algorithms stored in a memory 342. The memory 342 may be implemented, for instance, as a combination of volatile and non-volatile memory, such as DRAM, EEPROM, flash memory, and the like.

The memory 342 may also store identifying information regarding the electronic device 304. The identifying information may comprise a unique identification number or some other form of distinguishing the electronic device 304 from other electronic devices. The identifying information may be transmitted along with the collected data by the controller 340.

The controller 340 generally enables greater levels of control over the components forming the electronic device 304. For instance, the controller 340 may be capable of controlling the amount of electrical energy delivered to the sensors 332 and 334. In effect, therefore, the controller 340 may be configured to control when the sensors 332 and 334 are to be operated. In addition, the controller 340 may control an optional power supply 344 of the electronic device 304.

The optional power supply 344 may comprise, for instance, any reasonably suitable commercially available electrical charge storage device, such as, a coil capacitor, battery, etc. The power supply 344 is considered optional because inclusion of the power supply 344 in the electronic device 304 may be limited to certain instances. For instance, the power supply 344 may be configured to store and deliver electrical energy to one or both of the sensors 332 and 334 in situations where one or both of the sensors 332 and 334 require electrical energy for durations greater than are possible from transient contact with the interface 330. By way of example, if reader device 302 is generally held in position to supply the electronic device 304 with RF waves 324 for a certain period of time and one or both of the sensors 332 and 334 require electrical energy for periods of time exceeding that period of time, the power supply 344 may be used to supply one or both of the sensors 332 and 334 with sufficient electrical energy to perform detection operations. This situation may arise, for instance, if the sensors 332 and 334 comprise mineral detecting devices that may require the additional electrical energy to conduct tests to determine mineral concentrations in the tree 110.

In this instance, for example, the controller 340 may be configured to store the detected condition information in the memory 342. The stored information may be transmitted to the reader device 322, for instance, when the reader device 322 is again in position to receive the information from the electronic device 304.

The data collected by the reader device 302 from the electronic device 304 may be stored in the memory 308. In addition or alternatively, the reader device 302 may be configured to transmit the collected data to a separate computing device. Communications between the reader device 302 and the separate computing device may be effectuated through a wired protocol, such as IEEE 802.3, etc., or wireless protocols, such as IEEE 802.11b, 802.11g, wireless serial connection, Bluetooth, any standard radio frequency protocols or, combinations thereof. In any respect, the collected data may be stored along with information identifying the element 110 to which the electronic device 304 is associated. For instance, a chart or spreadsheet may be created to correlate the collected data with the locations from which the data was collected. The locations may be in the form of identifying information obtained from the controller 340 along with their known positions. Alternatively, locations may be in the form of other means for tracking the agricultural elements 110. Thus, for instance, since the locations of the agricultural elements 110 may be known, and the locations of the electronic devices 304 may be correlated to respective agricultural elements 110, the locations where the data was collected may also be known.

The collected data may be analyzed by a user or the computing device to determine whether, for instance, additional resources are required as well as where the additional resources may be required. By way of example, if the collected data indicates that the moisture content around a particular tree 110 is below a threshold level, it may be determined that additional water should be supplied to that tree 110. As another example, fertilizer may be applied around particular trees 110 depending upon the detected levels of their sap productions. In this regard, the distribution of resources may substantially be optimized since use of the resources may be limited or controlled to the times when they are needed.

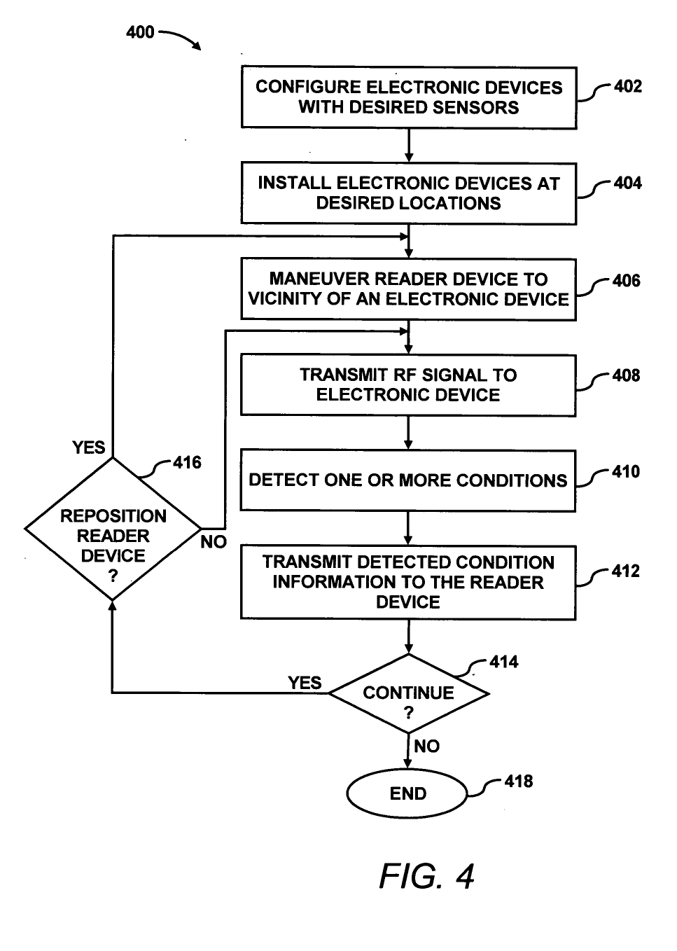

FIG. 4 illustrates a flow diagram of an operational mode 400 of a method for data collection, which employs a reader device and an electronic device. It is to be understood that the following description of the operational mode 400 is but one manner of a variety of different manners in which the data collection method may be practiced. It should also be apparent to those of ordinary skill in the art that the operational mode 400 represents a generalized illustration and that other steps may be added or existing steps may be removed, modified or rearranged without departing from a scope of the data collection method described herein.

The description of the operational mode 400 is made with reference to the block diagram 300 illustrated in FIG. 3, and thus makes reference to the elements cited therein. It should, however, be understood that the operational mode 400 is not limited to the elements set forth in the block diagram 300. Instead, it should be understood that the operational mode 400 may be practiced by a data collection system having a different configuration than that set forth in the block diagram 300.

As shown in FIG. 4, one or more electronic devices 304 may be configured with desired sensors 332 and 334 at step 402. Configuration of the one or more electronic devices 304 with the sensors 332 and 334 may be performed, for instance, by a manufacturer of the one or more electronic devices 304. Alternatively, a user may configure the one or more electronic devices 304 with the desired sensors 332 and 334. The sensors 332 and 334 included in the one or more electronic devices 304 may be selected according to the types of data desired to be collected. Thus, for instance, if moisture detection is desired, one or both of the sensors 332 and 334 may comprise moisture sensors. As another example, if the concentrations of various minerals in a tree 110 are to be detected, one or both of the sensors 332 and 334 may comprise mineral detecting sensors.

At step 404, the one or more electronic devices 304 may be positioned at desired locations. Thus, for instance, the one or more electronic devices 304 may be positioned in and/or around various agricultural elements 110, such as trees in an orchard. In this regard, the one or more electronic devices 304 may be positioned to detect the one or more conditions described in greater detail hereinabove.

The one or more electronic devices 304, or more particularly, the sensors 332 and 334 may not be functional until the one or more electronic devices 304 receive electrical energy in the form of RF waves 324 from a reader device 302. Thus, the sensors 332 and 334 may be unable to detect the one or more conditions until a reader device 302 is in relatively close proximity. In this regard, the reader device 302 is generally configured to interrogate the electronic devices 304 by supplying the electronic devices 304 with RF waves 324. The distance at which the reader device 302 is capable of providing sufficient electrical energy to enable the sensors 332 and 334 of the electronic device 304 to become active depends upon the energy output of the reader device 302. Hence, the required proximity between the reader device 302 and the electronic device 304 depends on the strength of the energy output of the reader device 302.

Depending upon the required proximity described above, the reader device 302 may be maneuvered to a location within the required proximity as indicated at step 406. At step 408, the reader device 302 may be configured to continuously output RF waves 324 from the interface 310 such that the one or more electronic devices 304 may become activated once the reader device 302 is within the required proximity to the one or more electronic devices 304. Alternatively, at step 408, the reader device 302 may operate the interface 310 to output RF waves 324 when it is assumed that the reader device 302 is within the required proximity to the one or more electronic devices 304. Operation of the interface 310 may be performed either automatically or manually. In this case, the electrical energy required to operate the interface 310 may substantially be reduced, thus enabling conservation of the energy stored in the power supply 316.

One or more of the electronic devices 304 may receive the RF waves 324 and may convert the RF waves 324 into electrical energy for use by the components of the electronic devices 304. Thus, in those electronic devices 304 that receive the RF waves 324 from the reader device 302, the sensors 332 and 334 may detect the one or more conditions at step 410. The data pertaining to the detected one or more conditions may be transmitted to the reader device 302 at step 412.

As an alternative, the detected condition information may be stored in the memory 342 of the electronic device 304 and may be communicated to the reader device 302 at a later time. For instance, the electronic device 304 may transmit the collected data when the reader device 304 interrogates the electronic device 304 at during a subsequent pass of the reader device 304. In addition, the detected condition information may be stored in the memory 342 in situations where the sensors 332 and 334 require additional time to perform the detection step as described hereinabove.

At step 414, it may be determined whether the operational mode 400 is to continue. The operational mode 400 may be continued, for instance, if there are additional electronic devices 304 from which data is to be collected. Thus, if it is determined that the operational mode 400 is to continue, it may be determined whether the reader device 302 requires repositioning at step 416. If the reader device 302 requires repositioning, the reader device 302 maybe maneuvered to the vicinity, that is, within the required proximity to another electronic device 302 as indicated at step 406. The reader device 302 may not require repositioning, if, for instance, the electronic device 304 from which the reader device 302 is to receive information is already within the required proximity to the reader device 302. In any respect, steps 408-416 may be repeated any number of times to thereby collect data from desired ones of the electronic devices 304.

If, however, at step 414, it is determined that the operational mode 400 is to be discontinued, the operational mode 400 may end as indicated at step 418. The operational mode 400 may end, for instance, when data from all of the desired electronic devices 304 has been collected.

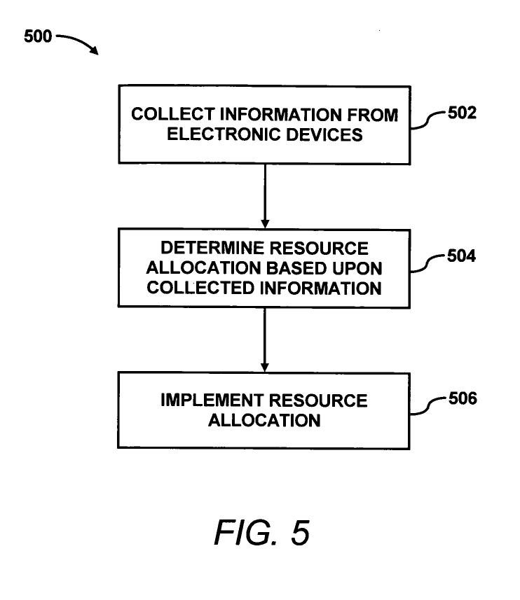

FIG. 5 illustrates a flow diagram of an operational mode 500 of a method for implementing resource allocation based upon data collected by a reader device from an electronic device. It is to be understood that the following description of the operational mode 500 is but one manner of a variety of different manners in which the resource allocation method may be practiced. It should also be apparent to those of ordinary skill in the art that the operational mode 500 represents a generalized illustration and that other steps may be added or existing steps may be removed, modified or rearranged without departing from a scope of the resource allocation method described herein.

In the operational mode 500, the reader device 302 collects information or data from the electronic devices at step 502. The data collection may be performed in manners consistent with the operational mode 400 depicted in FIG. 4. At step 504, the allocation of resources may be determined based upon the collected data. More particularly, it may be determined which of the agricultural elements 110 have deficient resources, for instance, water, minerals, fertilizer, pesticides, etc. Based upon this determination, it may be determined whether any of the agricultural elements 110 require additional resources. Thus, for example, water may be supplied to those agricultural elements 110 that may have insufficient moisture levels.

The determination of resource allocation may be performed either manually or by a computing device. If performed manually, a user may determine whether resources are lacking through a comparison with desired resource levels. If performed with a computing device, a set of desired conditions may be programmed or otherwise stored, for instance, in the form of a chart or a look-up table in the computing device. The computing device may compare the detected conditions with the desired conditions to determine whether detected conditions are within the limits of the desired conditions. If the detected conditions are outside of the desired conditions, the computing device may suggest appropriate measures to overcome the deficiencies. For instance, the computing device may access a database containing information pertaining to certain corrective measures when deficiencies are detected. This information may be in the form of, for instance, a look-up table.

Once the resource allocation determination is made at step 504, the resource allocation scheme may be implemented at step 506. Again, the agricultural elements 110 having deficient resources may be provided with those resources. In this regard, the use of resources may substantially be focalized to thereby minimize the costs associated with their use.

The allocation of resources may also be performed manually or automatically. In terms of automatic performance, the computing device described above may be configured to operate one or more machines for delivering the resources. In this regard, if the computing device determines that conditions at one or more locations are outside of a desired condition range, the computing device may control the one or more machines to supply the one or more locations with resources to bring the conditions within the desired condition range.

Some of the operations set forth in the operational modes 400 and 500 may be contained as a utility, program, or subprogram, in any desired computer accessible medium. In addition, the operational mode 400 may be embodied by a computer program, which can exist in a variety of forms both active and inactive. For example, it can exist as software program(s) comprised of program instructions in source code, object code, executable code or other formats. Any of the above can be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a storage card, CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

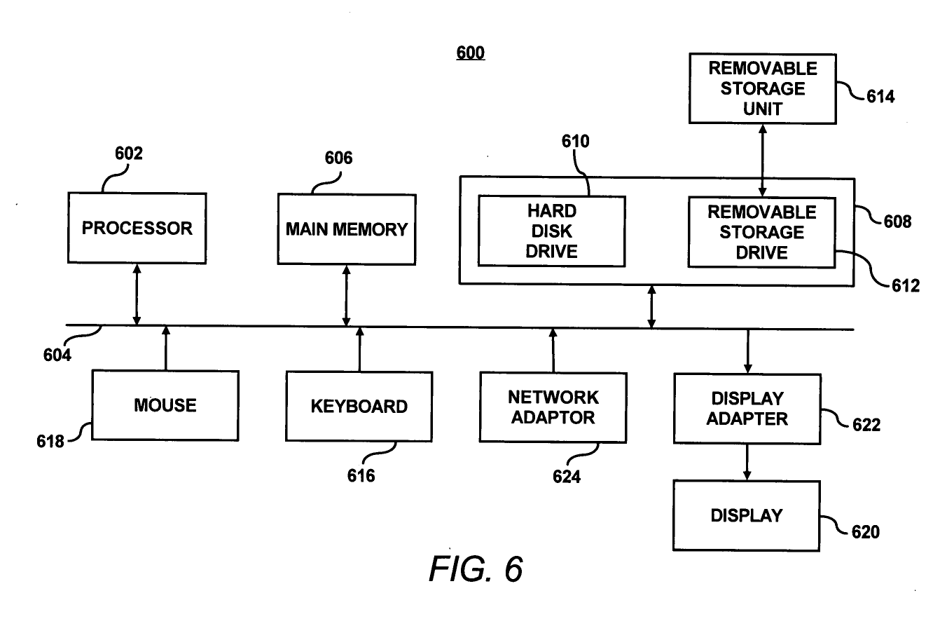

FIG. 6 illustrates an exemplary computer system 600, according to an embodiment of the invention. The computer system 600 may include, for example, the reader device and/or the computing device. In this respect, the computer system 600 may be used as a platform for executing one or more of the functions described hereinabove with respect to the various components of the data collection system as well as in the performance of the operational modes 400 and 500.

The computer system 600 includes one or more controllers, such as a processor 602. The processor 602 may be used to execute some or all of the steps described in the operational modes 400 and 500 described hereinabove. Commands and data from the processor 602 are communicated over a communication bus 604. The computer system 600 also includes a main memory 606, such as a random access memory (RAM), where the program code for, for instance, the controller 306, may be executed during runtime, and a secondary memory 608. The secondary memory 608 includes, for example, one or more hard disk drives 610 and/or a removable storage drive 612, representing a floppy diskette drive, a magnetic tape drive, a compact disk drive, etc., where a copy of the program code for the provisioning system may be stored.

The removable storage drive 610 reads from and/or writes to a removable storage unit 614 in a well-known manner. User input and output devices may include a keyboard 616, a mouse 618, and a display 620. A display adaptor 622 may interface with the communication bus 604 and the display 620 and may receive display data from the processor 602 and convert the display data into display commands for the display 620. In addition, the processor 602 may communicate over a network, e.g., the Internet, LAN, etc., through a network adaptor 624.

It will be apparent to one of ordinary skill in the art that other known electronic components may be added or substituted in the computer system 600. In addition, the computer system 600 may include a system board or blade used in a rack in a data center, a conventional “white box” server or computing device, etc. Also, one or more of the components in FIG. 6 may be optional (e.g., user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

1. A system for data collection regarding agricultural elements, said system comprising:
a reader device having an interface for generating RF waves;
a plurality of electronic devices associated with agricultural elements, wherein the electronic devices are located in a relatively fixed positioned with respect to the associated agricultural elements, said electronic devices having radio frequency identification devices (RFIDs) configured to activate one or more sensors for collecting at least one condition in response to receipt of the RF waves from the reader device; and
wherein the electronic devices are configured to transmit data collected by the one or more sensors to the reader device.

2. The system according to claim 1, wherein the agricultural elements comprise at least one of trees and vines.

3. The system according to claim 2, wherein one or more of the plurality of electronic devices are positioned in the ground adjacent to the agricultural elements and wherein the one or more sensors comprises at least one of a moisture detector and a mineral detector.

4. The system according to claim 3, wherein the one or more sensors comprise a plurality of sensors positioned at various depths in the ground and wherein the one or more of the plurality of electronic devices comprise a section that extends at least one of above the ground and near to the surface of the ground, said section having an interface and a transmitter for receiving RF waves and for sending data to the reader device.

5. The system according to claim 2, wherein one or more of the plurality of electronic devices are positioned on at least one of a trunk and a branch of the agricultural element, and the one or more sensors comprises at least one of a sap detector, an insect detector, a mineral detector, and a growth detector.

6. The system according to claim 1, further comprising:
a motorized vehicle configured to carry the reader device to various locations in the respective vicinities of the plurality of electronic devices.

7. The system according to claim 1, wherein one or more of the plurality of electronic devices comprise a power supply configured to recharge through receipt of RF waves from the reader device, wherein the power supply is configured to supply power to the one or more sensors in the absence of RF waves from the reader device.

8. The system according to claim 7, wherein the one or more of the plurality of electronic devices comprise a memory configured to store data collected by the one or more sensors.

9. A method of collecting data regarding agricultural elements with a reader device, one or more electronic devices being associated with the agricultural elements, said method comprising:
maneuvering the reader device configured to emit an RF wave to a vicinity of one or more of the electronic devices;
transmitting RF waves to the one or more electronic devices in the vicinity of the reader device;
in the one or more electronic devices, activating a sensor through receipt of the RF waves and detecting at least one condition with the sensor; and
transmitting the detected at least one condition to the reader device.

10. The method according to claim 9, further comprising:
configuring the at least one electronic device with one or more sensors, said one or more sensors being selected according to desired condition detection; and
installing the at least one electronic device at various locations with respect to the agricultural elements prior to the step of maneuvering the reader device.

11. The method according to claim 10, wherein the agricultural elements comprise at least one of trees and vines, and wherein the step of installing the at least one electronic device comprises installing the at least one electronic device in the ground adjacent to the at least one of the trees and vines, and wherein the step of detecting at least one condition comprises detecting at least one of a moisture content and a mineral content in the ground.

12. The method according to claim 11, wherein the step of detecting at least one of a moisture content and a mineral content comprises detecting at least one of a moisture content and a mineral content at various depths in the ground.

13. The method according to claim 10, wherein the agricultural elements comprise at least one of trees and vines, and wherein the step of installing the at least one electronic device comprises installing the at least one electronic device on the agricultural elements, and wherein the step of detecting at least one condition comprises detecting one or more of sap flow, insect population, minerals, and growth of the agricultural element.

14. The method according to claim 9, wherein the reader device is positioned on a motorized vehicle, and wherein the step of maneuvering the reader device comprises maneuvering the motorized vehicle to the vicinity of the one or more electronic devices.

15. The method according to claim 9, further comprising:
maneuvering the reader device to a vicinity of another electronic device;
transmitting RF waves to the another electronic device;
activating a sensor on the another electronic device;
detecting at least one condition with the sensor of the another electronic device; and
transmitting the detected at least one condition to the reader device.

16. The method according to claim 9, wherein the one or more electronic devices comprise a rechargeable power supply, the method further comprising:
recharging the power supply through receipt of the RF wave; and
providing electrical charge to the sensor from the power supply to enable the sensor to continue performing the step of detecting the at least one condition in the absence of RF waves from the reader device.

17. The method according to claim 16, wherein the one or more electronic devices further comprises a memory, the method further comprising:
storing the detected at least condition in the memory; and
transmitting the detected at least condition to the reader device when the reader device is again in a proximity to the one or more electronic devices.

18. A method of supplying resources to agricultural elements, said method comprising:
collecting data related to one or more conditions of the agricultural elements from electronic devices associated with the agricultural elements, wherein the electronic devices comprise radio frequency identification devices;
determining a resource allocation scheme based upon the collected data; and
implementing the resource allocation scheme.

19. The method according to claim 18, wherein the step of determining a resource allocation scheme is performed by a computing device.

20. The method according to claim 18, wherein the step of implementing the resource allocation scheme is performed by a computing device.

21. A system for data collection regarding agricultural elements, said system comprising:
means for interrogating a means for detecting one or more conditions regarding the agricultural elements, the means for detecting being positioned at least one of on or adjacent to respective ones of the agricultural elements, wherein the means for detecting comprises a radio frequency identification device; and
means for transmitting the one or more conditions to the means for interrogating.

22. The system according to claim 21, further comprising:
means for maneuvering the means for interrogating to respective vicinities of a plurality of means for detecting.

23. The system according to claim 21, wherein the agricultural elements comprise at least one of trees and vines.

24. The system according to claim 21, wherein the means for detecting comprises a means for supplying power to the means for detecting, wherein the means for supplying power is configured to receive power and become recharged through receipt of RF waves emitted by the means for interrogating.

25. The system according to claim 24, wherein the means for detecting further comprises a means for storing detected one or more conditions.

26. A computer readable storage medium on which is embedded one or more computer programs, said one or more computer programs implementing a method for supplying resources to agricultural elements, said one or more computer programs comprising a set of instructions for:
collecting data related to one or more conditions of the agricultural elements from electronic devices associated with the agricultural elements, wherein the electronic devices comprise radio frequency identification devices;
determining a resource allocation scheme based upon the collected data; and
implementing the resource allocation scheme.
